(19) United States
(12) Patent Application Publication
(10) Pub. No.: US 2025/0384272 A1
(43) Pub. Date: Dec. 18, 2025

(54) SYSTEMS AND METHODS FOR CONSTRUCTING NEURAL NETWORKS

(71) Applicant: Salesforce, Inc., San Francisco, CA (US)

(72) Inventors: Shiva Kumar Pentyala, Mountain View, CA (US); Bin Bi, Bellevue, WA (US); Regunathan Radhakrishnan, San Francisco, CA (US); Sitaram Asur, Newark, CA (US); Na (Claire) Cheng, Yarrow Point, WA (US)

(21) Appl. No.: 18/742,519

(22) Filed: Jun. 13, 2024

(51) Int. Cl. G06N 3/082; G06N 3/045; G06N 3/084

(52) U.S. Cl. CPC G06N 3/082; G06N 3/045; G06N 3/084

(57) ABSTRACT

Embodiments also provide an LLM adapter training and merging framework that builds a new neural network model by merging a first LLM (stronger) with an adapter that has been trained in conjunction with a second LLM (weaker). Specifically, the adapter may be trained in conjunction with a smaller LLM to perform a specific task or adapt to a particular domain. The trained adapter is then merged with a different (larger) LLM to produce a new model. In this way, developers may select compatible LLMs as base models to merge with trained adapters to produce new models without additional training and/or finetuning the adapter with different LLMs. The one-time domain specific adapter training may be applied to any subsequent developments in merging compatible models with the trained specific adapter, thus enhancing computational efficiency of neural network model adaptation.

### CROSS-REFERENCE

The instant application is related to co-pending and commonly-assigned U.S. nonprovisional application Ser. No. ______ (attorney docket no. 70689.341US01), and Ser. No. ______ (attorney docket no. 70689.342US01), filed on the same day, which are hereby expressly incorporated herein by reference in their entirety.

### TECHNICAL FIELD

The embodiments relate generally to neural networks and machine learning systems, and more specifically to construction neural networks by merging a base neural network and an adapter neural network.

### BACKGROUND

Neural networks such as Large Language Models (LLMs) are often trained on vast amounts of training data to perform various language tasks, such as question and answering, summarization, paraphrasing, machine translation, and/or the like. Initially, LLMs are trained on diverse datasets to develop a broad understanding of language. However, fine-tuning or retraining using specific datasets on specific domains is often necessary to adapt the pretrained LLMs to specific tasks or domains, such as generating a legal document, and/or the like. This constant retraining can be costly in terms of computational resources, time, and expertise required for data curation and model training.

Therefore, there is a need to improve efficiency of adapting neural networks across different tasks and domains.

### BRIEF DESCRIPTION OF THE DRAWINGS

FIG. 1 is a simplified diagram illustrating an example training process of adapting a base neural network model via an adapter, according to embodiments described herein.

FIGS. 2A-2B are simplified diagrams illustrating example architectures of adding an adapter module to the base neural network model, according to embodiments described herein.

FIGS. 3A-3B are simplified diagrams illustrating merging trained adapter modules to different base neural network models to produce new neural network models, according to embodiments described herein.

FIG. 4 is a simplified diagram of an illustrative map showing a set of LLMs being created by progressively merging existing LLMs, according to embodiments described herein.

FIG. 5 is a simplified diagram illustrating aspects of selectively pruning a trained adapter module before merging with a base neural network model, according to embodiments described herein.

FIG. 6 is a simplified diagram illustrating an example of generating a new sparsified adapter module after selectively pruning a trained adapter module, according to embodiments described herein.

FIG. 7 is a simplified diagram illustrating a computing device implementing the neural network construction through merging described in FIGS. 1-6, according to one embodiment described herein.

FIG. 8 is a simplified diagram illustrating the neural network structure implementing the neural network construction module described in FIG. 7, according to some embodiments.

FIG. 9 is a simplified block diagram of a networked system suitable for implementing the neural network construction through merging described in FIGS. 1-6 and other embodiments described herein.

FIG. 10 is an example logic flow diagram illustrating an example method of constructing a new neural network to perform a specific task, according to embodiments described herein.

FIG. 11 is an example logic flow diagram illustrating an example method of merging a trained adapter neural network with a target base neural network to create a new neural network, according to embodiments described herein.

FIG. 12 is an example pseudo-code segment illustrating examples of computing spectral similarities between neural network components for pruning an adapter module, according to embodiments described herein.

FIGS. 13A-13C are example performance charts illustrating spectral similarities of different layers of an adapter module compared with the base neural network, according to embodiments described herein.

FIG. 14 is an example performance table illustrating example performance of merged models on specific tasks and domains, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

To train or adapt a neural network such as an LLM to perform a specific task or on a specific domain, e.g., to understand and generate a legal document, to understand and answer mathematical questions, and/or the like, instead of training and retraining the entire LLM using a training dataset for the specific tasks or domain, an adapter module may be used. An adapter module is usually a smaller neural network module compared to an LLM, that is added to the original LLM and trained to perform specific tasks. During training, instead of updating the weights and/or parameters of the entire LLM, only the weights of the adapter modules are updated while keeping the bulk of the original LLM unchanged. This approach helps reduce the computational cost and memory footprint associated with finetuning LLMs for specific tasks or on a specific domain.

After being updated during training, the adapter module may then be merged with a base LLM such that the merged new model is adapted to perform the specific task or on the specific domain. Existing merging approaches often fail to account for spectral and/or magnitude characteristics of feature spaces among the neural networks being combined. Thus, training the adapter modules in conjunction with different base neural network models without accounting for feature space similarities may increase the risk of feature interference. In other words, among different versions of adapter modules trained with different base neural network models, it is often unclear which part of the adapter module contributes to learning task-specific features and which part of the adapter module contributes to learning task-agnostic features.

Hence, existing adapter module mostly require retraining when the adapter module is to be merged with a new base model. This 1:1 LLM-adapter retraining process is computationally costly and can sometimes be redundant when the underlying training dataset remains the same or largely overlapping.

In addition, traditionally, trained adapter modules may be merged with a base LLM directly, e.g., by integrating an adapter layer into each layer of the base LLM, etc. Such integration efforts alone may be computationally costly, and also results in new neural network models having enhanced complexity.

In view of the need to an efficient framework to adapt neural networks to perform specific tasks on specific domains, embodiments provide a merging framework that selectively merges pretrained model parameters of an LLM and retrained adapter weights. Specifically, the merging framework measures a similarity metric between a pretrained base LLM and an adapter that is retrained for a specific task or domain, and then prunes one or more components (weights or layers) of the adapter that have a high similarity with the base LLM and thus are likely to be redundant. The pruned adapter with only sparse features that are most dissimilar to the base LLM is then merged with the base LLM to produce a new neural network model that is adapted for the specific task or domain. In this way, redundant features may be pruned from adapter modules before merging. Remaining weights of the sparse adapter focuses on targeted domain-specific enhancements that the base LLM lacks. Adapter integration can thus achieve specialized and efficient LLM adaptation by preserving the unique features and capabilities of each component of the neural network.

Embodiments also provide an LLM adapter training and merging framework that builds a new neural network model by merging a first LLM (stronger) with an adapter that has been trained in conjunction with a second LLM (weaker). Specifically, the adapter May be trained in conjunction with a smaller LLM to perform a specific task or adapt to a particular domain. The trained adapter is then merged with a different (larger) LLM to produce a new model. In this way, developers may select compatible LLMs as base models to merge with trained adapters to produce new models without additional training and/or finetuning the adapter with different LLMs. The one-time domain specific adapter training may be applied to any subsequent developments in merging compatible models with the trained specific adapter, thus enhancing computational efficiency of neural network model adaptation.

In this way, neural networks can be constructed, created or adapted without repetitive retraining and/or fine-tuning. With enhanced computational efficiency, neural network technology is thus improved.

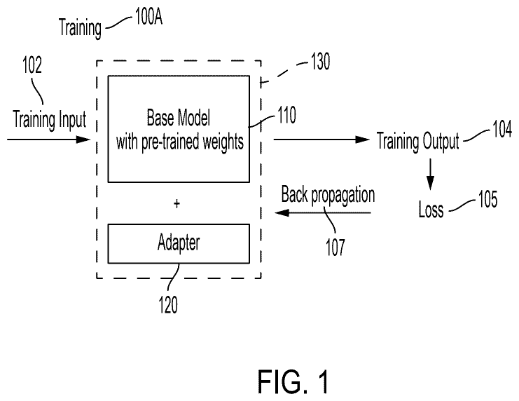

FIG. 1 is a simplified diagram illustrating an example training process 100 of adapting a base neural network model via an adapter, according to embodiments described herein. To adapt a base neural network model 100 with pretrained weights for a specific task, such as to generate and understand a legal document, to understand and provide a solution to a mathematical problem, and/or the like, an adapter module 120 may be used to learn the task-specific and/or domain-specific features.

During training 100, the adapter 120 may be trained in conjunction with the base model 110, but the parameters of the base model 110 are frozen during backpropagation. Specifically, the adapter 120 may be added to the layers of the base model 110. The adapter 120 may comprise additional neural network layers that are task-specific. These layers may be added either on top of or in between the layers of the base 110.

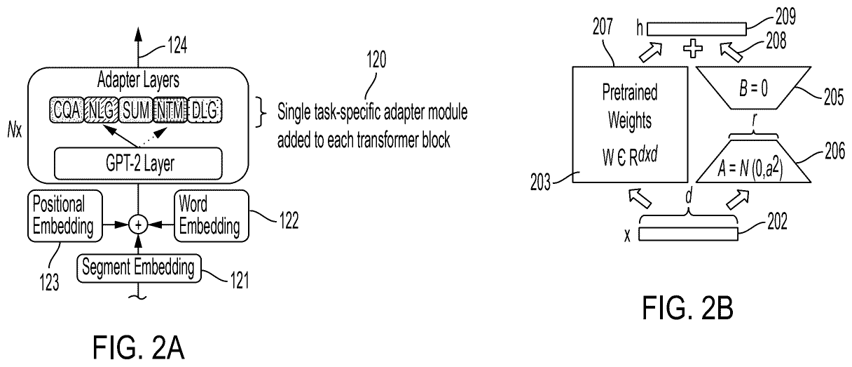

In one embodiment, adapter 120 may be added to base model 110 in a way that does not increase the model size. For example, parameters of base model 110 may be updated as an average of weight matrices of the base model 110 and adapter 120 after zeroing out some weights in the adapter matrices. Additional examples of adding the adapter 120 to the base model 110 may be illustrated in FIGS. 2A-2B.

During training 100, a training input 102 may be fed to the combined neural network 130 of the base model 110 and the adapter 120, which in turn generates a training output 104. For example, the training input 102 may comprise a mathematical problem,

$${lim}_{n \to ∞} {( 1 + \frac{1}{n} )}^{n} = ?$$

And the combined model 130 may generate a predicted training output 104, which may be used to compute a loss 105. The parameters of the base model 110 are kept fixed (frozen) during backpropagation 107 based on the loss 105. In other words, the gradients from the loss function 105 are not propagated through the parameters of the base model 110 during backpropagation. By freezing these parameters, the knowledge and representations learned by the pre-trained base model 110 is preserved.

In the meantime, during backpropagation 107, only the parameters of the adapter layers 120 are updated during training. These parameters are trained to adapt the representations learned by the base model 110 to the specific task or domain.

In one embodiment, the training process 100 may involve joint optimization of the adapter parameters of adapter 120 and the parameters of the base model 110. Thus, even though the gradients from the loss function 105 are not propagated through the base model 110 parameters during backpropagation, the presence of the base model layers 110 still affects the representations learned by the adapter layers 120.

FIGS. 2A-2B are simplified diagrams illustrating example architectures of adding an adapter module 120 to the base neural network model 110, according to embodiments described herein. As shown in FIG. 2A, when the base model (e.g., 110 in FIG. 1) has a Transformer architecture, a single task-specific adapter module 120 may be added to each transformer block. For example, the adapter 120 may receive segment embedding 121, positional embedding 123, word embedding 122 from other layers in a Transformer block, and in turn generate an adapter output 124. During training, the gradients from a training loss are propagated through the added adapter layers 120 in every Transformer block.

In another example, FIG. 2B illustrates a Low Rank Adapter (LoRA) that is added to a pretrained base model 110 (such as a Transformer model) through low-rank parameterization. For example, given the pre-trained weight matrix 203 of base model 110: W with a dimension of d×d, the adapter weight change matrix ΔW may be decomposed into two low-rank projection matrices A 206 and B 205. The two low-rank projection matrices A 206 and B 205 each be initialized as a normal distribution A=N (0, σ²) and B=0, and then updated during training.

When a new training input x 202 enters the combined model of base model and the adapter, x will be multiplied with W 203 and ΔW (A and B) separately. So the dimension of x multiplying with W becomes 1×d, and the dimension of x multiplying with ΔW is also 1×d. The two output vectors 207 and 208 from the multiplication are summed coordinate-wise to become the final output h 209 so that h=W₀x+ΔW x=W⁰x+BAx.

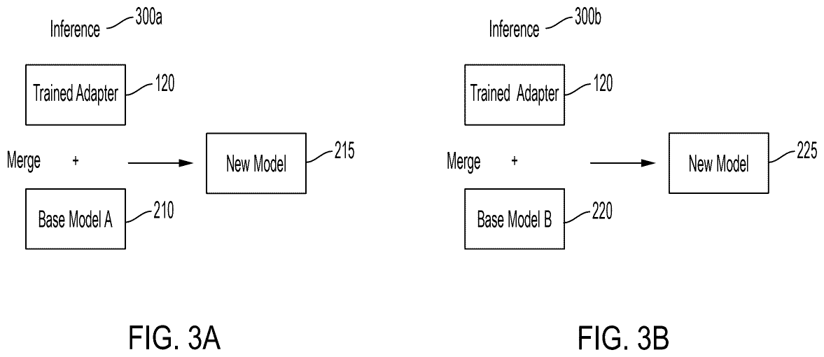

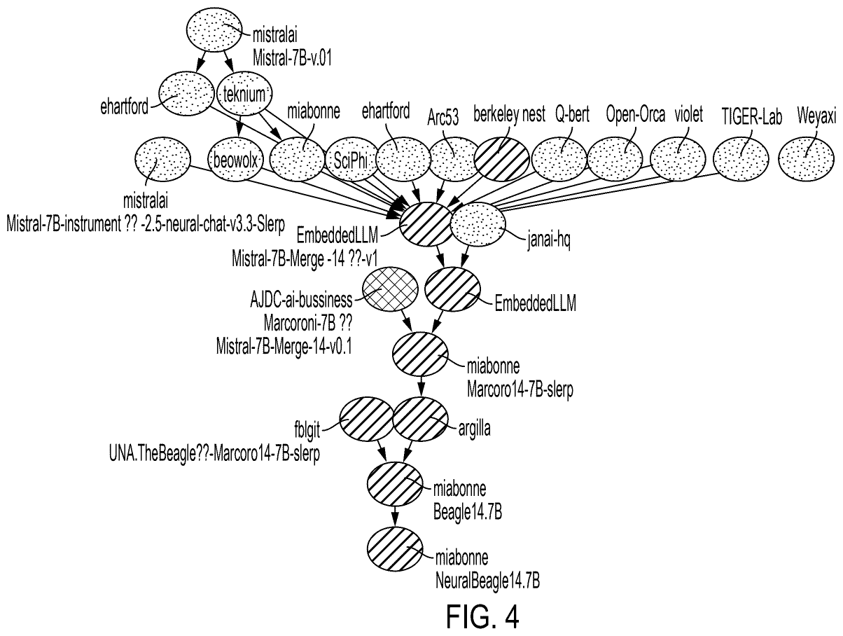

FIGS. 3A-3B are simplified diagrams illustrating merging trained adapter modules to different base neural network models to produce new neural network models, according to embodiments described herein. After the training process 100 shown in FIG. 1, trained adapter module 120 may be integrated with different base models 210, 220 to produce new models 215, 225. For example, in one implementation, an adapter may be trained in conjunction with a “weaker” base model (having a smaller number of total layers and weights) using the training process shown in FIG. 1, and then the trained adapter may be merged with a “stronger’ base model (having a greater number of total layers and weights) that is compatible with the “weaker” base model. The compatibility between two base models may be determined based on their relationships in a library of base models (as shown in FIG. 4).

FIG. 4 is a simplified diagram of an illustrative map showing a set of LLMs being created by progressively merging existing LLMs, according to embodiments described herein. As shown, a library of base models such as LLMs may be created via merging with adapters, or merging with each others on top of public models such as LLMs. The tree structure illustrates examples of merging different models under Mistral ancestor family to generate new stronger base models. For example, each circle in the tree structure represents a neural network model, and the ingress arrows represent the merging of different models that results in the respective neural network model. Therefore, a neural network model may be compatible with one or more of its ancestor models on the tree structure.

In one embodiment, two models may be compatible if one model is the ancestor model of the other on the tree structure. The closer, or fewer degrees of separation of the two models, the two models may likely be more similar or more compatible.

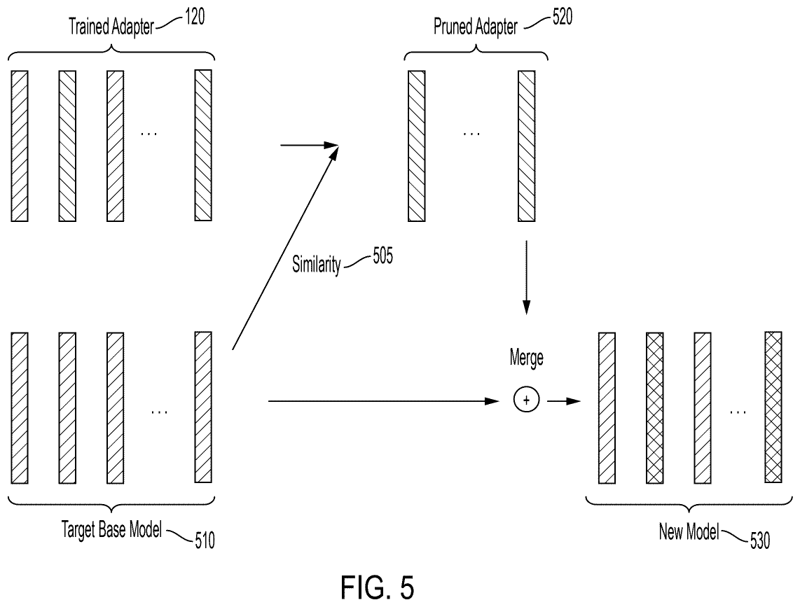

FIG. 5 is a simplified diagram illustrating aspects of selectively pruning a trained adapter module before merging with a base neural network model, according to embodiments described herein. In merging a trained adapter module with different base neural network models, the trained adapter module may be selectively pruned to reduce the risk of feature interferences. In other words, portions of the trained adapter module that are updated to reflect task-specific features may be kept, while portions of the trained adapter module that are updated to reflect task-agnostic features may be removed. In this way, only task-specific adapter components are left to be integrated with the base model.

In one embodiment, to achieve this, the trained adapter module 120 and the target base model 510 may be compared. For example, as LoRA adapters and base models are linearly merged per layer, the matrix similarity 505 may be computed between these individual layers to identify the redundant features.

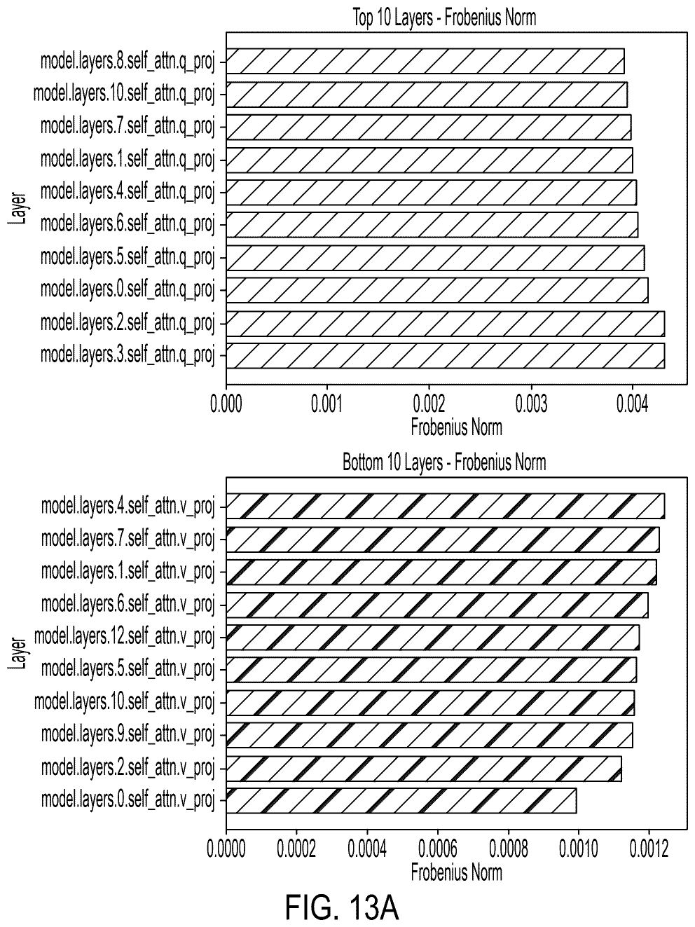

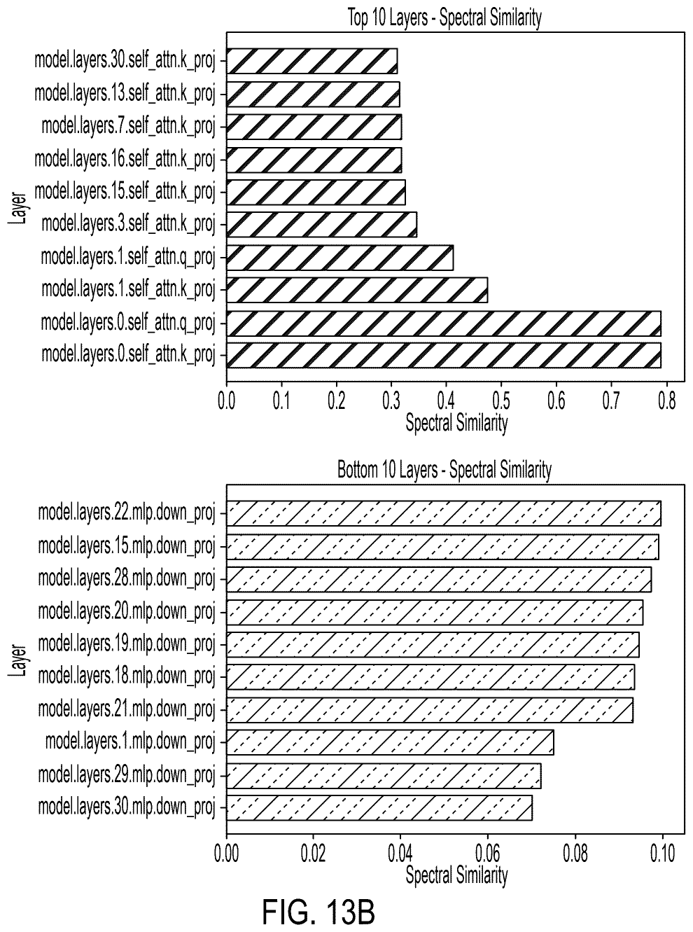

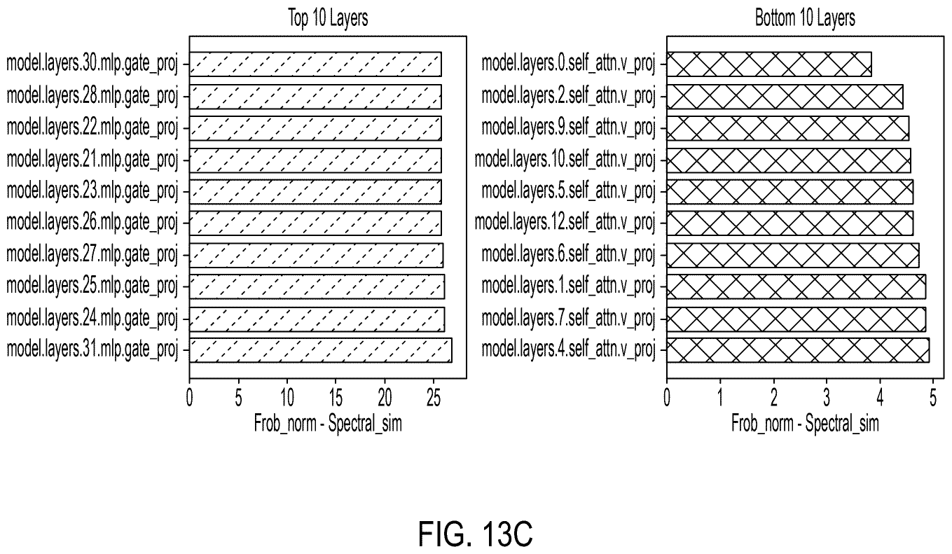

In one embodiment, given a first matrix representing one or more layers (e.g., matrices 205, 206 in a LoRA adapter shown in FIG. 2B) of the trained adapter 120 and a second matrix representing the corresponding base model layer (e.g., 203 in FIG. 2B), the similarity metric 505 may be computed as a Frobenius norm of the difference of the two matrices. For example, the Frobenius norm is computed as the square root of the sum of the absolute squares of all elements of (the first matrix-the second matrix). For example, FIG. 13A shows the top 10 layers having the highest Frobenius norm (most different from base model layers) and the bottom 10 layers having the lowest Frobenius norm (least different from base model layers) in an adapter module, where the top 10 layers are the most different from the base models, e.g., the bottom layers learning task agnostic features while top layers learning task specific features.

In one embodiment, the similarity metric 505 may be computed as a cosine-similarity based spectral similarity. For example, each of the first matrix representing the one or more layers of the trained adapter 120 and the second matrix representing the corresponding base model layer 510 may be decomposed via singular value decomposition (SVD). The cosine-similarity between the set of singular values of the first matrix and the set of singular vales of the second matrix may then be computed to indicate how similar or different the trained adapter layers are to the base model layer 510. For example, FIG. 13B shows the top 10 layers having the highest spectral similarity (most different from base model layers) and the bottom 10 layers having the lowest spectral similarity (least different from base model layers) in an adapter module.

In one embodiment, the similarity metric 505 may be computed as (Frobenius norm-spectral similarity). For example, FIG. 13C shows the top 10 layers having the highest (Frobenius norm-spectral similarity) scores (most different from base model layers) and the bottom 10 layers having the lowest (least different from base model layers) in an adapter module.

In this way, the bottom layers (e.g., 10, 20, etc.), and/or layers having Frobenius norm less than a threshold (not sufficiently different from the base model) may be pruned from the adapter module 120. Similarly, within the same layer, weights may be pruned by comparing the weights of a layer in a base model and computing Frobenius norm or spectral similarity.

The pruned adapter 520 may then be merged with the target base model 510 to result in the new model 530, which may be improved in both model size and computational efficiency.

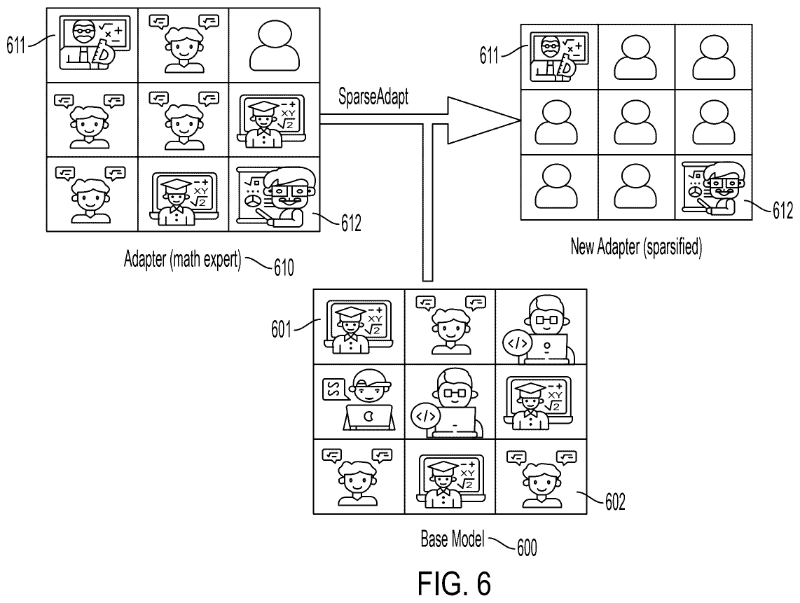

FIG. 6 is a simplified diagram illustrating an example of generating a new sparsified adapter module after selectively pruning a trained adapter module, according to embodiments described herein. For example, a base neural network model 600 may be pretrained to process at least some simple language based mathematical problems, such as solving simple equations 601, question answering of basic calculations 602, and/or the like. An adapter module 610 may be trained to perform advanced mathematical operations and/or data analysis. Thus, the trained adapter 610 may be sparsified by comparing with the base model 600, and only elements (such as layers and/or weights) 611 and 612 that learn task-specific features of advanced mathematical operations and/or data analysis, which are significantly different from elements such as 601, 602 in the base model 600, are preserved in the adapter.

### Computer and Network Environment

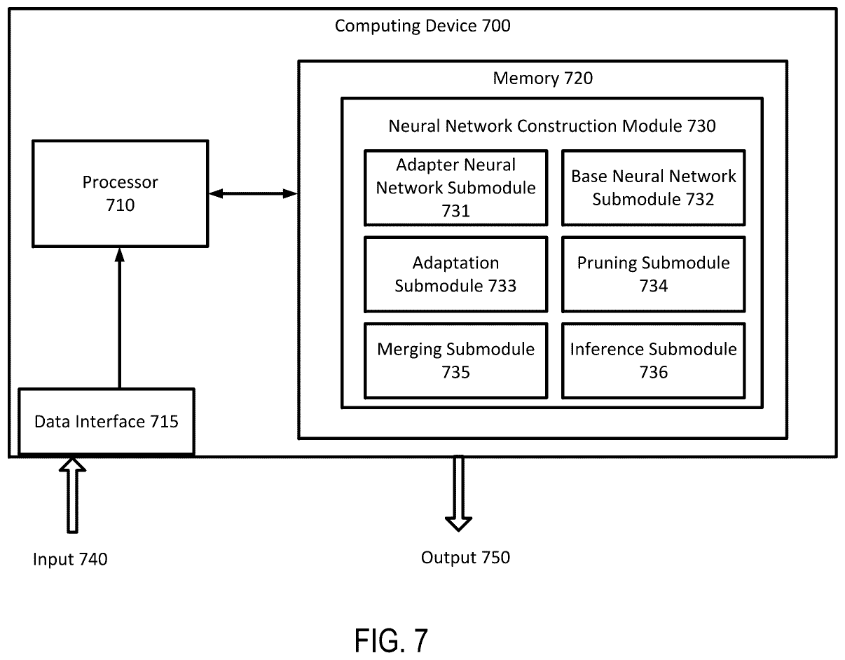

FIG. 7 is a simplified diagram illustrating a computing device implementing the neural network construction through merging described in FIGS. 1-6, according to one embodiment described herein. As shown in FIG. 7, computing device 700 includes a processor 710 coupled to memory 720. Operation of computing device 700 is controlled by processor 710. And although computing device 700 is shown with only one processor 710, it is understood that processor 710 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 700. Computing device 700 may be implemented as a stand-alone subsystem, as a board added to a computing device, and/or as a virtual machine.

Memory 720 may be used to store software executed by computing device 700 and/or one or more data structures used during operation of computing device 700. Memory 720 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 710 and/or memory 720 may be arranged in any suitable physical arrangement. In some embodiments, processor 710 and/or memory 720 may be implemented on a same board, in a same package (e.g., system-in-package), on a same chip (e.g., system-on-chip), and/or the like. In some embodiments, processor 710 and/or memory 720 may include distributed, virtualized, and/or containerized computing resources. Consistent with such embodiments, processor 710 and/or memory 720 may be located in one or more data centers and/or cloud computing facilities.

In some examples, memory 720 may include non-transitory, tangible, machine readable media that includes executable code that when run by one or more processors (e.g., processor 710) may cause the one or more processors to perform the methods described in further detail herein. For example, as shown, memory 720 includes instructions for neural network construction module 730 that may be used to implement and/or emulate the systems and models, and/or to implement any of the methods described further herein. neural network construction module 730 may receive input 740 such as an input text via the data interface 715 and generate an output 750 which may be a natural language processing task output.

The data interface 715 may comprise a communication interface, a user interface (such as a voice input interface, a graphical user interface, and/or the like). For example, the computing device 700 may receive the input 740 (such as a training text input) from a networked database via a communication interface. Or the computing device 700 may receive the input 740, such as a user utterance, from a user via the user interface.

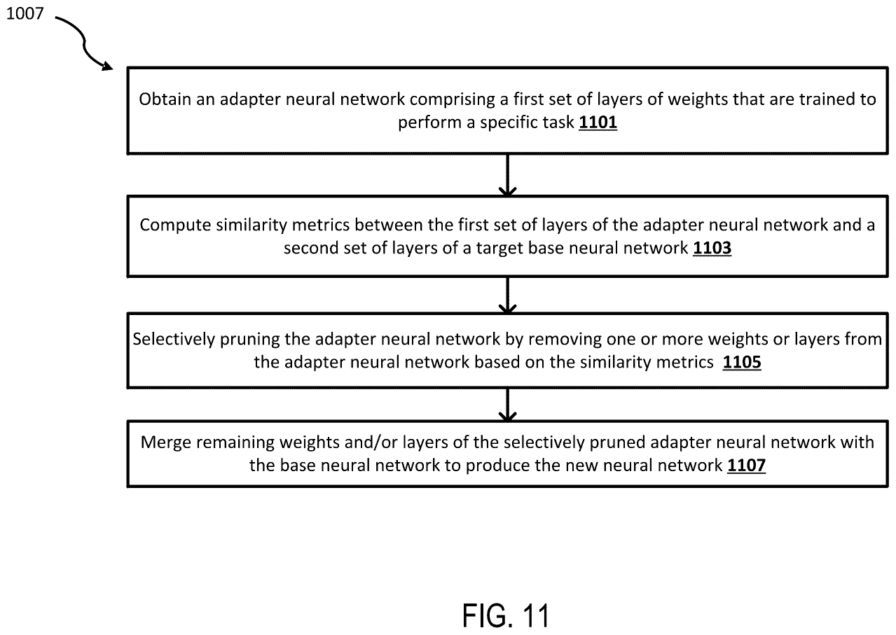

In some embodiments, the neural network construction module 730 is configured to adapt a base neural network model such as an LLM to perform a specific task. The neural network construction module 730 may further include an adapter neural network submodule 731 (e.g., 120 in FIG. 1), a base neural network submodule 732 (e.g., 110 in FIG. 1), an adaptation submodule 733 (e.g., for performing training process 100 in FIG. 1), a pruning submodule 734 (e.g., for conducting the method 1007 in FIG. 11), a merging submodule 735, and an inference submodule 736.

Some examples of computing devices, such as computing device 700 may include non-transitory, tangible, machine readable media that include executable code that when run by one or more processors (e.g., processor 710) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

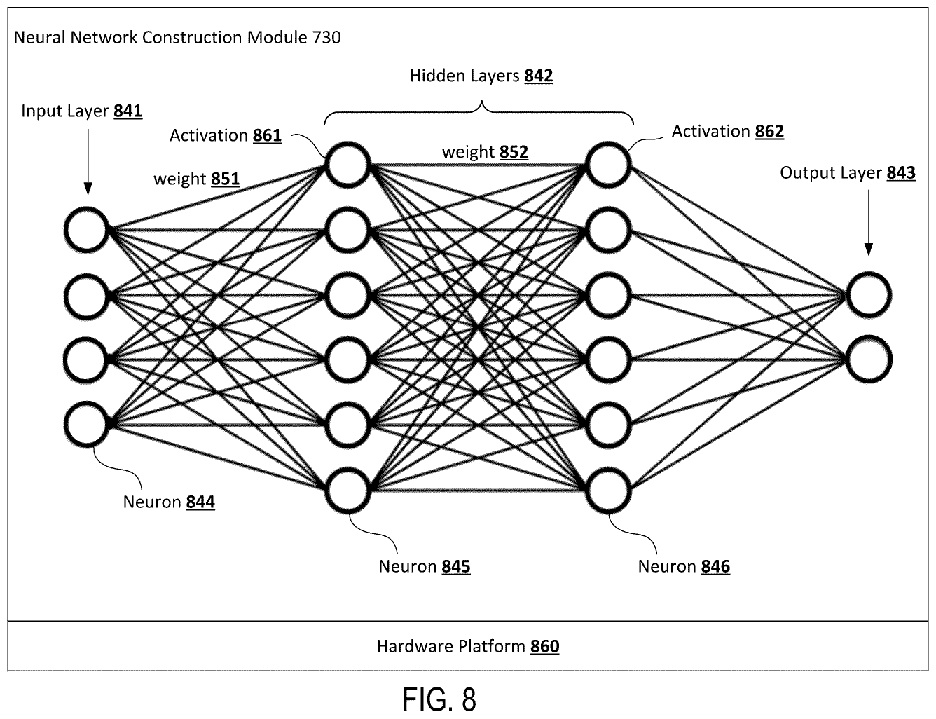

FIG. 8 is a simplified diagram illustrating the neural network structure implementing the neural network construction module described in FIG. 7, according to some embodiments. In some embodiments, the neural network construction module 730 and/or one or more of its submodules 731-736 may be implemented at least partially via an artificial neural network structure shown in FIG. 7. The neural network comprises a computing system that is built on a collection of connected units or nodes, referred to as neurons (e.g., 844, 845, 846). Neurons are often connected by edges, and an adjustable weight (e.g., 851, 852) is often associated with the edge. The neurons are often aggregated into layers such that different layers may perform different transformations on the respective input and output transformed input data onto the next layer.

For example, the neural network architecture may comprise an input layer 841, one or more hidden layers 842 and an output layer 843. Each layer may comprise a plurality of neurons, and neurons between layers are interconnected according to a specific topology of the neural network topology. The input layer 841 receives the input data (e.g., 740 in FIG. 7), such as an input image and an input text. The number of nodes (neurons) in the input layer 841 may be determined by the dimensionality of the input data (e.g., the length of a vector of a latent feature of the input image). Each node in the input layer represents a feature or attribute of the input.

The hidden layers 842 are intermediate layers between the input and output layers of a neural network. It is noted that two hidden layers 842 are shown in FIG. 8B for illustrative purpose only, and any number of hidden layers may be utilized in a neural network structure. Hidden layers 842 may extract and transform the input data through a series of weighted computations and activation functions.

For example, as discussed in FIG. 8, the neural network construction module 530 receives an input 840 of an input image and transforms the input into an output 850 of an image representation. To perform the transformation, each neuron receives input signals, performs a weighted sum of the inputs according to weights assigned to each connection (e.g., 851, 852), and then applies an activation function (e.g., 861, 862, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 841 is transformed into rather different values indicative data characteristics corresponding to a task that the neural network structure has been designed to perform.

The output layer 843 is the final layer of the neural network structure. It produces the network's output or prediction based on the computations performed in the preceding layers (e.g., 841, 842). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the neural network construction module 530 and/or one or more of its submodules 831-335 may comprise the transformative neural network structure of layers of neurons, and weights and activation functions describing the non-linear transformation at each neuron. Such a neural network structure is often implemented on one or more hardware processors 810, such as a graphics processing unit (GPU). An example neural network may be a Transformer model, and/or the like.

In one embodiment, the neural network construction module 730 and its submodules 731-736 may be implemented by hardware, software and/or a combination thereof. For example, the neural network construction module 730 and its submodules 731-736 may comprise a specific neural network structure implemented and run on various hardware platforms 860, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 860 used to implement the neural network structure is specifically configured based on factors such as the complexity of the neural network, the scale of the tasks (e.g., training time, input data scale, size of training dataset, etc.), and the desired performance.

In one embodiment, the neural network based neural network construction module 730 and one or more of its submodules 731-736 may be trained by iteratively updating the underlying parameters (e.g., weights 851, 852, etc., bias parameters and/or coefficients in the activation functions 861, 862 associated with neurons) of the neural network based on the loss. For example, during forward propagation, the training data such as a training image or a training text are fed into the neural network. The data flows through the network's layers 841, 842, with each layer performing computations based on its weights, biases, and activation functions until the output layer 843 produces the network's output 850. In some embodiments, output layer 843 produces an intermediate output on which the network's output 850 is based.

The output generated by the output layer 843 is compared to the expected output (e.g., a “ground-truth”) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 843 to the input layer 841 of the neural network. These gradients quantify the sensitivity of the network's output to changes in the parameters. The chain rule of calculus is applied to efficiently calculate these gradients by propagating the gradients backward from the output layer 843 to the input layer 841.

Parameters of the neural network are updated backwardly from the last layer to the input layer (backpropagating) based on the computed negative gradient using an optimization algorithm to minimize the loss. The backpropagation from the last layer 843 to the input layer 841 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as image animation.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in applications of intelligent agents.

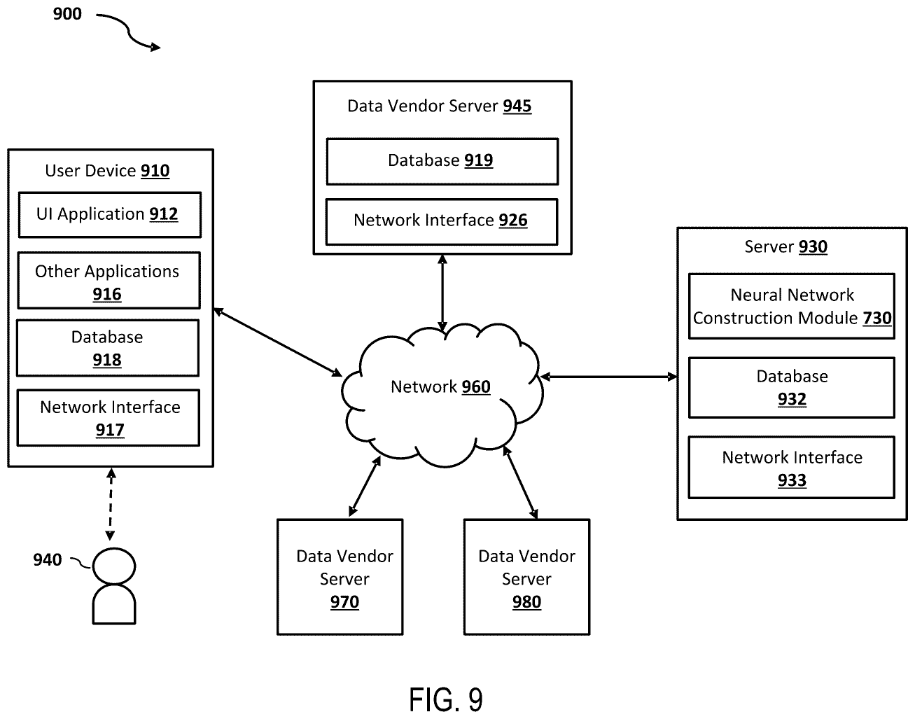

FIG. 9 is a simplified block diagram of a networked system suitable for implementing the neural network construction through merging described in FIGS. 1-6 and other embodiments described herein. In one embodiment, system 900 includes the user device 910 which may be operated by user 940, data vendor servers 945, 970 and 980, server 930, and other forms of devices, servers, and/or software components that operate to perform various methodologies in accordance with the described embodiments. Exemplary devices and servers may include device, stand-alone, and enterprise-class servers which may be similar to the computing device 700 described in FIG. 7, operating an OS such as a MICROSOFT® OS, a UNIX® OS, a LINUX® OS, or other suitable device and/or server-based OS. It can be appreciated that the devices and/or servers illustrated in FIG. 9 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 910, data vendor servers 945, 970 and 980, and the server 930 may communicate with each other over a network 960. User device 910 may be utilized by a user 940 (e.g., a driver, a system admin, etc.) to access the various features available for user device 910, which may include processes and/or applications associated with the server 930 to receive generated LLM outputs.

User device 910, data vendor server 945, and the server 930 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 900, and/or accessible over network 960. For example, each data vendor servers may provide domain specific training datasets to server 930.

User device 910 may be implemented as a communication device that may utilize appropriate hardware and software configured for wired and/or wireless communication with data vendor server 945 and/or the server 930. For example, in one embodiment, user device 910 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 910 of FIG. 9 contains a user interface (UI) application 912, and/or other applications 916, which may correspond to executable processes, procedures, and/or applications with associated hardware. For example, the user device 910 may receive a message indicating an LLM output from the server 930 and display the message via the UI application 912. In other embodiments, user device 910 may include additional or different modules having specialized hardware and/or software as required.

In various embodiments, user device 910 includes other applications 916 as may be desired in particular embodiments to provide features to user device 910. For example, other applications 916 may include security applications for implementing client-side security features, programmatic client applications for interfacing with appropriate application programming interfaces (APIs) over network 960, or other types of applications. Other applications 916 may also include communication applications, such as email, texting, voice, social networking, and IM applications that allow a user to send and receive emails, calls, texts, and other notifications through network 960. For example, the other application 916 may be an email or instant messaging application that receives a forecast result from the server 930. Other applications 916 may include device interfaces and other display modules that may receive input and/or output information. For example, other applications 916 may contain software programs for asset management, executable by a processor, including a graphical user interface (GUI) configured to provide an interface to the user 940 to view the visualized output.

User device 910 may further include database 918 stored in a transitory and/or non-transitory memory of user device 910, which may store various applications and data and be utilized during execution of various modules of user device 910. Database 918 may store user profile relating to the user 940, predictions previously viewed or saved by the user 940, historical data received from the server 930, and/or the like. In some embodiments, database 918 may be local to user device 910. However, in other embodiments, database 918 may be external to user device 910 and accessible by user device 910, including cloud storage systems and/or databases that are accessible over network 960.

User device 910 includes at least one network interface component 917 adapted to communicate with data vendor server 945 and/or the server 930. In various embodiments, network interface component 917 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 945 may correspond to a server that hosts database 919 to provide training datasets including training images/texts to the server 930. The database 919 may be implemented by one or more relational database, distributed databases, cloud databases, and/or the like.

The data vendor server 945 includes at least one network interface component 926 adapted to communicate with user device 910 and/or the server 930. In various embodiments, network interface component 926 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 945 may send asset information from the database 919, via the network interface 926, to the server 930.

The server 930 may be housed with the neural network construction module 730 and its submodules described in FIG. 7. In some implementations, neural network construction module 730 may receive domain-specific or task-specific training data from database 919 at the data vendor server 945 via the network 960 for training (e.g., process 100 in FIG. 1). At inference, the generated output may also be sent to the user device 910 for review by the user 940 via the network 960.

The database 932 may be stored in a transitory and/or non-transitory memory of the server 930. In one implementation, the database 932 may store data obtained from the data vendor server 945. In one implementation, the database 932 may store parameters of the neural network construction module 530. In one implementation, the database 932 may store previously generated tensor vectors, and the corresponding input feature vectors.

In some embodiments, database 932 may be local to the server 930. However, in other embodiments, database 932 may be external to the server 930 and accessible by the server 930, including cloud storage systems and/or databases that are accessible over network 960.

The server 930 includes at least one network interface component 933 adapted to communicate with user device 910 and/or data vendor servers 945, 970 or 980 over network 960. In various embodiments, network interface component 933 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 960 may be implemented as a single network or a combination of multiple networks. For example, in various embodiments, network 960 may include the Internet or one or more intranets, landline networks, wireless networks, and/or other appropriate types of networks. Thus, network 960 may correspond to small scale communication networks, such as a private or local area network, or a larger scale network, such as a wide area network or the Internet, accessible by the various components of system 900.

### Example Work Flow

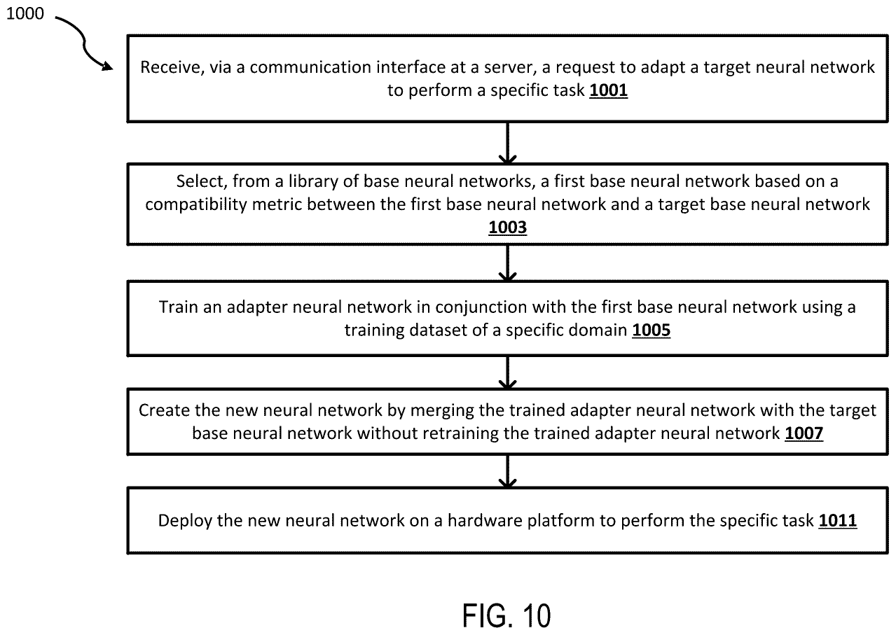

FIG. 10 is an example logic flow diagram illustrating an example method of constructing a new neural network to perform a specific task, according to embodiments described herein. One or more of the processes of method 1000 may be implemented, at least in part, in the form of executable code stored on non-transitory, tangible, machine-readable media that when run by one or more processors may cause the one or more processors to perform one or more of the processes. In some embodiments, method 1000 corresponds to the operation of the neural network construction module 730 (e.g., FIGS. 7 and 9).

As illustrated, the method 1000 includes a number of enumerated steps, but aspects of the method 1000 may include additional steps before, after, and in between the enumerated steps. In some aspects, one or more of the enumerated steps may be omitted or performed in a different order.

At step 1001, a communication interface (e.g., 715 in FIG. 7, 933 in FIG. 9) at a server (e.g., 930 in FIG. 9) may receive a request to adapt a target neural network to perform a specific task.

At step 1003, the server may select, from a library of base neural networks, based on a compatibility metric between the first base neural network and a target base neural network. For example, the library of base neural networks may be built by merging one or more neural networks to produce a new neural network, which contains a tree structure (as shown in FIG. 4) indicating merging relationships between the base neural networks. The compatibility metric indicates that the target base neural network is generated from merging the first base neural network and another neural network. For another example, the first base neural network has a smaller size than the target base neural network, such that training the adapter neural network with the first base neural network may be computationally efficient.

At step 1005, an adapter neural network (e.g., 120 in FIG. 1) may be trained in conjunction with the first base neural network (e.g., 110 in FIG. 1) using a training dataset of a specific domain. For example, a combination (e.g., 130 in FIG. 1) of the adapter neural network and the first base neural network may jointly generate a training output (e.g., 104 in FIG. 1) based on a training input (e.g., 102 in FIG. 1) from the training dataset. Weights of the adapter neural network (e.g., 120 in FIG. 1) may be updated based on a training loss (e.g., 105 in FIG. 1) computed from the training output while keeping weights of the first base neural network (e.g., 110 in FIG. 1) unchanged.

At step 1007, the new neural network (e.g., 215, 225 in FIGS. 3A-3B) may be created by merging the trained adapter neural network (e.g., 120 in FIGS. 3A-3B) with the target base neural network without retraining the trained adapter neural network. For example, a first set of layers of the trained adapter neural network may be merged with a second set of layers of the target base neural network based on a per-layer basis.

At step 1011, the new neural network may be deployed on a hardware platform (e.g., 860 in FIG. 8) to perform the specific task, e.g., performing mathematical computation tasks in response to mathematical problem inputs (e.g., FIG. 6).

FIG. 11 is an example logic flow diagram illustrating an example method 1007 of merging a trained adapter neural network with a target base neural network to create a new neural network, according to embodiments described herein. One or more of the processes of method 1007 may be implemented, at least in part, in the form of executable code stored on non-transitory, tangible, machine-readable media that when run by one or more processors may cause the one or more processors to perform one or more of the processes. In some embodiments, method 1000 corresponds to the operation of the neural network construction module 730 (e.g., FIGS. 7 and 9).

As illustrated, the method 1007 includes a number of enumerated steps, but aspects of the method 1007 may include additional steps before, after, and in between the enumerated steps. In some aspects, one or more of the enumerated steps may be omitted or performed in a different order.

At step 1101, an adapter neural network (e.g., 120 in FIG. 5) may be obtained, comprising a first set of layers of weights that are trained to perform a specific task, e.g., through training process 100 in FIG. 1.

At step 1103, the adapter neural network may be selectively pruned by removing one or more weights or layers based on similarity metrics between the first set of layers of the adapter neural network (e.g., 120 in FIG. 5) and a second set of layers of a base neural network (e.g., 510 in FIG. 5). For example, a similarity metric between a first matrix representing a first layer of the adapter neural network and a second matrix representing the corresponding layer of the target base neural network may be computed, and the first layer may be removed from the adapter neural network before merging when the similarity metric indicates that the first layer is redundant.

In one implementation, the similarity metric is a Frobenius norm of a difference between the first matrix representing the first layer and the second matrix representing the corresponding layer.

In one implementation, the similarity metric is computed by: computing a first set of singular values of the first matrix and a second set of singular vales of the second matrix through singular value decomposition of the first matrix and the second matrix. The similarity metric is a cosine similarity between the first set of singular values and the second set of singular values.

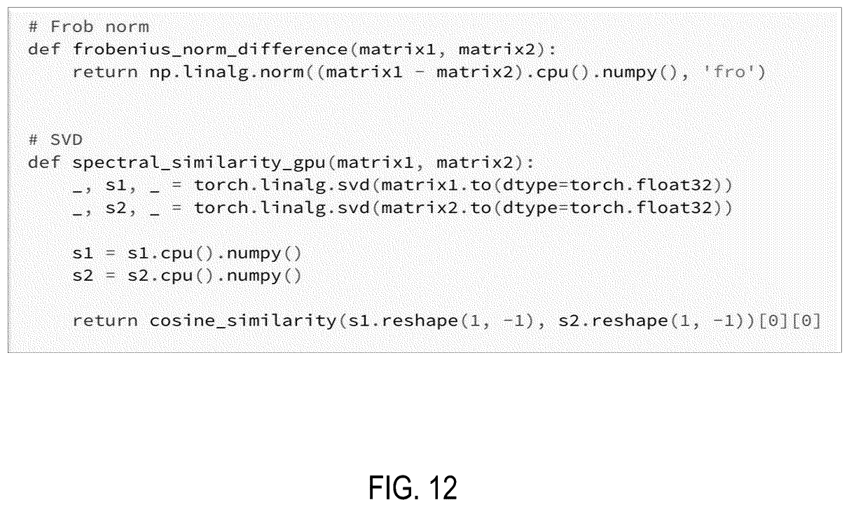

In one implementation, the similarity metric is computed as a difference between Frobenius norm and the cosine similarity. For example, FIG. 12 is an example pseudo-code segment illustrating examples of computing similarity metrics between neural network components for pruning an adapter module.

At step 1105, the remaining weights and/or layers of the selectively pruned adapter neural network (e.g., 520 in FIG. 5) may be merged with the base neural network (e.g., 510 in FIG. 5) to produce the new neural network (e.g., 530 in FIG. 5).

At step 1107, the new neural network may be deployed on a hardware platform to perform the specific task at inference, e.g., performing mathematical computation tasks in response to mathematical problem inputs (e.g., FIG. 6).

For example, the similarity metrics comprise computing the Frobeius norm of the difference between two matrices. For another example, the spectral similarity metric is computed by decomposing the matrices into singular values, and the cosine similarity between the two sets of singular values is computed.

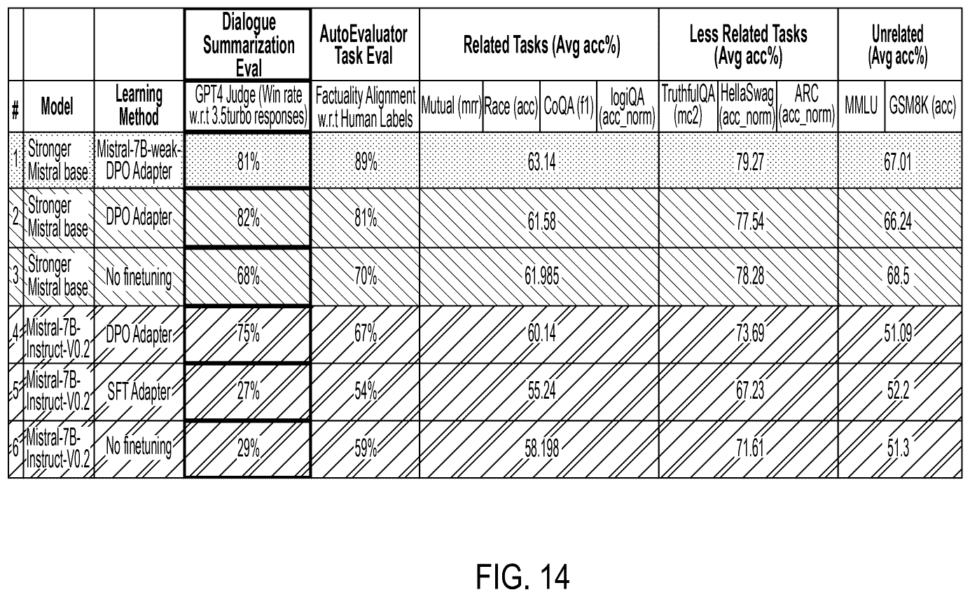

FIG. 14 is an example performance table illustrating example performance of merged models on specific tasks and domains, according to embodiments described herein. As shown in the chart, different Mistral base models are evaluated on dialogue summarization tasks, with different adapters.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of constructing a new neural network to perform a specific task, the method comprising:
obtaining an adapter neural network comprising a first set of layers of weights that are trained to perform a specific task;
selectively pruning the adapter neural network by removing one or more weights or layers based on similarity metrics between the first set of layers of the adapter neural network and a second set of layers of a base neural network;
merging remaining weights and/or layers of the selectively pruned adapter neural network with the base neural network to produce the new neural network; and
deploying the new neural network on a hardware platform to perform the specific task at inference.

2. The method of claim 1, further comprising:
merging at least a first layer from the first set of layers of the adapter neural network with a corresponding layer from a second set of layers of the base neural network on a per-layer basis.

3. The method of claim 2, wherein the selectively pruning the adapter neural network comprises:
computing a similarity metric between a first matrix representing the first layer and a second matrix representing the corresponding layer; and
removing the first layer from the adapter neural network before merging when the similarity metric indicates that the first layer is redundant.

4. The method of claim 3, wherein the similarity metric is a Frobenius norm of a difference between the first matrix representing the first layer and the second matrix representing the corresponding layer.

5. The method of claim 4, wherein the similarity metric is computed by:
computing a first set of singular values of the first matrix and a second set of singular vales of the second matrix through singular value decomposition of the first matrix and the second matrix; and
computing the similarity metric as a cosine similarity between the first set of singular values and the second set of singular values.

6. The method of claim 5, wherein the similarity metric is computed as a difference between Frobenius norm and the cosine similarity.

7. The method of claim 2, wherein the selectively pruning the adapter neural network comprises:
computing a weight similarity metric between a first matrix of weights in the first layer and a second matrix of weights in the corresponding layer; and
removing at least one weight from the first layer before merging when the weight similarity metric indicates that the at least one weight is redundant.

8. The method of claim 7, wherein the weight similarity metric is computed as a Frobenius norm, a cosine similarity or Frobenius norm minus the cosine similarity.

9. The method of claim 1, wherein the adapter neural network is trained in conjunction with a different base neural network using a training dataset of a specific domain by:
jointly generating, by a combination of the adapter neural network and the different base neural network, a training output based on a training input from the training dataset; and
updating weights of the first set of layers of the adapter neural network based on a training loss computed from the training output while keeping weights of the different base neural network unchanged.

10. The method of claim 9, wherein the base neural network is selected based on a compatibility matric with the different base neural network used for training the adapter neural network.

11. A system of constructing a new neural network to perform a specific task, the system comprising:
a communication interface;
a memory storing a plurality of processor-executable instructions; and
one or more processors executing the plurality of processor-executable instructions to perform operations comprising:
obtaining an adapter neural network comprising a first set of layers of weights that are trained to perform a specific task;
selectively pruning the adapter neural network by removing one or more weights or layers based on similarity metrics between the first set of layers of the adapter neural network and a second set of layers of a base neural network;
merging remaining weights and/or layers of the selectively pruned adapter neural network with the base neural network to produce the new neural network; and
deploying the new neural network on a hardware platform to perform the specific task at inference.

12. The system of claim 11, wherein the operations further comprise:
merging at least a first layer from the first set of layers of the adapter neural network with a corresponding layer from a second set of layers of the base neural network on a per-layer basis.

13. The system of claim 12, wherein the operation of selectively pruning the adapter neural network comprises:
computing a similarity metric between a first matrix representing the first layer and a second matrix representing the corresponding layer; and
removing the first layer from the adapter neural network before merging when the similarity metric indicates that the first layer is redundant.

14. The system of claim 13, wherein the similarity metric is a Frobenius norm of a difference between the first matrix representing the first layer and the second matrix representing the corresponding layer.

15. The system of claim 14, wherein the similarity metric is computed by:
computing a first set of singular values of the first matrix and a second set of singular vales of the second matrix through singular value decomposition of the first matrix and the second matrix; and
computing the similarity metric as a cosine similarity between the first set of singular values and the second set of singular values.

16. The system of claim 15, wherein the similarity metric is computed as a difference between Frobenius norm and the cosine similarity.

17. The system of claim 12, wherein the operation of selectively pruning the adapter neural network comprises:
computing a weight similarity metric between a first matrix of weights in the first layer and a second matrix of weights in the corresponding layer; and
removing at least one weight from the first layer before merging when the weight similarity metric indicates that the at least one weight is redundant.

18. The system of claim 17, wherein the weight similarity metric is computed as a Frobenius norm, a cosine similarity or Frobenius norm minus the cosine similarity.

19. The system of claim 11, wherein the adapter neural network is trained in conjunction with a different base neural network using a training dataset of a specific domain by:
jointly generating, by a combination of the adapter neural network and the different base neural network, a training output based on a training input from the training dataset; and
updating weights of the first set of layers of the adapter neural network based on a training loss computed from the training output while keeping weights of the different base neural network unchanged.

20. A non-transitory processor-readable storage medium storing a plurality of processor-executable instructions for constructing a new neural network to perform a specific task, the instructions being executed by one or more processors to perform operations comprising:
obtaining an adapter neural network comprising a first set of layers of weights that are trained to perform a specific task;
selectively pruning the adapter neural network by removing one or more weights or layers based on similarity metrics between the first set of layers of the adapter neural network and a second set of layers of a base neural network;
merging remaining weights and/or layers of the selectively pruned adapter neural network with the base neural network to produce the new neural network; and
deploying the new neural network on a hardware platform to perform the specific task at inference.
